(19) United States
(12) Patent Application Publication
(10) Pub. No.: US 2007/0025367 A1
(43) Pub. Date: Feb. 1, 2007

(54) Mobile communications device and method for condition-dependent resuming of a delayed data transfer over a different network

(75) Inventor: Rudi Jozef Marie Wijnands, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/556,251

(22) PCT Filed: May 11, 2004
(86) PCT No.: PCT/IB04/50634

§ 371 Date: Nov. 10, 2005

(30) Foreign Application Priority Data
May 16, 2003 (EP) 031013840

(51) Int. Cl. H04L 12/56

(52) U.S. Cl. 370/401

(57) ABSTRACT

A portable communications device (2) and method is disclosed wherein data can be transferred between the portable communications device (2) and another portable communications device (4) through a first network (12) using a first network address. It is determined whether a condition related to the operation of the portable communications device (2) is above a minimum requirement, e.g. battery charge. Information is collected that is required for resuming the data transfer through an second network (14) using a second network address different from the first network address. The data transfer is allowed through the first network (12) if the condition is satisfied and delayed if the condition is not satisfied. If it is delayed the data transfer may be resumed later through the second network (14), e.g. via a synchronization interface and a host computer.

The present invention relates to portable communications devices and methods of operating the same as well as to networks including such portable communications devices and computer program products for implementing the methods on a suitable portable device as well as on a host device that synchronizes with the portable device. The portable device may be a portable multimedia device.

### TECHNICAL BACKGROUND

Portable multimedia devices, like MP3 players, PDAs, super phones, smart phones, pocket PCs etc. are becoming increasingly popular. A super or smart phone combines a mobile phone with the ability to access the Internet using a suitable protocol such as WAP or HDML. A PDA was originally a daily planner but some models have been extended to allow download of data from the Internet. Some PDA models have extended their usage to include wireless access to other networks. This wireless may be radio or optical access, i.e. either a radio wireless communication method such as Bluetooth™, or the provision of an infra-red optical wireless communications port.

PDAs and other portable devices can be connected to a “cradle” or “docking station” to synchronize the local content with a home station. The details of such a cradle differ between manufacturers. In some cases it can be as simple as a cable connection, e.g. to a COM communications port or a USB port of a personal computer, or an infra-red wireless connection to a similar port. In other systems, the cradle is a physical device with connectors for several functions, e.g. battery charging as well as two-way communication ports. Even a larger keyboard can be provided for data entry as described in US 2003/0006968. The cradle may be integrated with the host computer as described in US 2003/0041206. A cradle may therefore be described as an electro-optical (or other wireless communication, e.g. radio) or an electromechanical interface arrangement between a host computer and a portable multimedia device. The home station may be a personal computer, but in the future it is very likely a home server. Some PDA models can connect to networks, e.g. to an Ethernet Local Area Network (LAN) and can access their host computer via an internet address using a suitable LAN protocol such as TCP/IP.

Synchronization itself may take various forms. One or more of the following functions may be provided:
a) open and close databases on the portable device or the host,
b) upload or download data or a combination of both, as appropriate,
c) compare records on the portable device and the host,
d) add, delete or modify records in databases as appropriate on the portable device or the host,
e) convert data in one format on the portable device or host into data suitable for use on the host or portable device,
f) synchronize the clock on the host with the clock on the portable device,
g) “transaction processing”—transmission of data between the portable device and the host and processing of this data in one of these. Typically, this involves transfer of data from the portable device to the host for processing in the host. An example is order entry from the portable device to the host and further processing of the order on the host, e.g. communication of the order request to production management (for production planning) and to accounting (for billing).

Data synchronization between two computer systems is not new, e.g. between a laptop and a desktop computer. Recent versions of the Windows™ operating system supplied by Microsoft Corp., like Windows 2000™ support this feature by default. Synchronization involves a certain number of logical decisions, e.g. an algorithm to decide whether a record with an older datestamp on the host replaces a newer record on the portable device, when downloading from the host has been selected. For example, the newer record on the portable device may be a deleted record. These decisions become more complex if the portable device is synchronized with different hosts at different times as this allows many possibilities for the state of the records.

Schemes have also been devised for retrieving Internet based data, i.e. data which is linked to other data. For example, if only a homepage is downloaded, this generally does not provide very much useful information. AvantGo and Microsoft's Mobile Channels are two known synchronization schemes whereby a suitable selection of data (e.g. links down to a certain depth) are retrieved when the PDA is located in its cradle via the PC's Internet access, e.g. 56K telephone modem, cable TV or ADSL modem. By controlling the link depth an optimization can be made between downloading useful data which can be browsed and overloading the limited memory capabilities of the portable device.

Data may also be transferred between portable devices directly without the intervention of a host. Such as communication may be carried out by any suitable communication method, e.g. wireless radio, such as defined by the Bluetooth™ protocol, or optical wireless such as infra-red.

All these types of portable devices require more and more storage capacity and are therefore becoming portable storage devices. There are several options to equip such portable devices with storage. Until now non-volatile memories, like Memory Stick™ from Sony, have been the main storage devices. However, disk based storage devices with an acceptable form-factor for portable multimedia devices are becoming available too. An example is the IBM MicroDrive™. These disk-based devices are becoming popular, because they provide the user with large storage capacities and high-speed transfer rates, which until now have been the bottlenecks of the non-volatile memories.

So far a major disadvantage of disk based storage devices is the power consumption. Optimizations for power consumption have been done for the small form-factor hard disks, but they are still one of the key power consumers. Transmitters are another one of the key power consumers. Power consumption is a major issue when users want to transfer large amounts of data from/to their portable device to/from another device such as another portable device. Especially large amounts of data, which usually is the case with e.g. video files, can significantly reduce the battery lifetime of the portable device.

Wireless portable communications devices may connect to various networks, e.g. the GPRS service related to the GSM mobile telephone network, the UMTS service now being introduced in Europe or a wireless LAN, or to another computer by a suitable wireless communication channel such as an infra-red link. Short range wireless networks are known, e.g. those comprising piconets such as “Bluetooth”, which is controlled by the Bluetooth standard. A full specification for Bluetooth communications can be found through the Bluetooth Special Interests Group (SIG), whose web site can be found at “www.bluetooth.com” along with the current standard and related information.

The amount of signalling and setup required to make optical or radio wireless communications varies depending on the type of network. Networks such as GSM, UMTS and wireless LAN's require significant co-ordination, e.g. the provisions of a directory number or an IP or network address for each element of the network. In addition, the element must be registered with the network involved and the communications are organised via individualized basestations serving remote terminals. Such networks may be described as “infrastructure” networks. Such networks have permanent base stations and remote terminals or permanent master and slave devices. On the other hand point-to-point infra-red wireless communications may be set up between devices without a significant amount of co-ordination with other devices. Such a communication may be described as an “ad-hoc” communication. As two communicating devices form a minimal network, such a network may be said to be an “ad-hoc network”. A Bluetooth piconet requires some setup however it is still considered an ad-hoc network as each communicating device can take on either a master or slave role—this assignment is not individualized, i.e. permanent. A Bluetooth piconet can include one master, up to 7 slave units and up to 255 further devices in “standby” mode. Several piconets may be joined together into a scatternet. In a scatternet there may be up to 79 piconets—79 is the number of hopping frequencies which can be allocated. Both scattemets and piconets are ad-hoc networks.

### SUMMARY OF THE INVENTION

An object of the present invention is to provide portable communications devices, e.g. portable multimedia devices that do not suffer so severely from the battery limitations of the conventional devices.

The present invention provides a portable communications device comprising:

means to transfer data between the portable communications device and another device through a first network using a first network address;

means for determining whether a condition related to the operation of the portable communications device is above a minimum requirement;

means for collecting information required for resuming the data transfer through an second network using a second network address different from the first network; and

means for allowing the data transfer through the first network if the condition is satisfied and for delaying the data transfer through the first network if the condition is not satisfied. The portable communications device may further comprise means for resuming the data transfer through the second network. For example, it may further comprise means for instructing a host computer to resume the data transfer through the second network. A synchronization interface may be provided to which one or both of the portable communications device and the host computer can be coupled. The means for instructing a host computer may include the synchronization interface.

The portable communications device may have a battery and may be battery powered and the condition may be a state of charge of the battery before the communication through the first network is carried out. Alternatively, the condition may be a state of charge of the battery estimated assuming the communication through the first network would have been completed. The condition may be a quality of a signal received from the other device.

The information to be collected may include the second network address, the second network address being a network address of a host computer associated with the other device.

The portable communications device may also be a computing device. In particular it may be a programmable computing device which may be programmed to execute programs suitable for enterprise applications. The first network may be an ad-hoc network and the second network may be an infrastructure network. The host computer may comprise means for initiating a network connection to the other device through the second network.

The present invention provides a method of operating a portable communications device, the method comprising:

determining that data is to be transferred between the portable communications device and another device through a first network using a first network address;

determining whether a condition related to the operation of the portable communications device is above a minimum requirement;

collecting information required for resuming the data transfer through a second network using a second network address different from the first network address; and

allowing the data transfer through the first network if the condition is satisfied and delaying the data transfer through the first network if the condition is not satisfied. The present invention is not necessarily limited to the order of steps in this method. For instance, the determination of whether the condition is met can be made at any time, e.g. at regular intervals and not just after the determination that a message is to be sent.

The present invention also includes a computer program product comprising code which when executed on a portable communications device enables the portable device to:

determine if there is to be a transfer of data between the portable communications device and another device through a first network using a first network address;

determine whether a condition related to an operation of the portable communications device is above a minimum requirement;

collect information required for resuming the data transfer through a second network using a second network address; and

allow the data transfer through the first network if the condition is satisfied and delay the data transfer through the first network if the condition is not satisfied. The computer program product may be stored on any suitable signal storage means that is a computer/machine readable storage medium.

In one aspect of the present invention, to overcome the above problem with known devices, it is proposed that power consuming data transfers are queued until the portable devices are connected to a cradle (also known as a docking station). A cradle is connected to a power supply such as mains electricity, a powerful battery, e.g. a car battery, or a solar panel and the portable device therefore does not need to call upon its own battery. Any suitable connection, e.g. an Internet connection, which generally is provided by a personal computer or in the future by the home server, can then be used to do the power consuming data transfers.

It is an advantage of the present invention that it can also be used to delay and resume data transfers if two portable communications devices loose radio contact. In this case, a data transfer may for example be resumed if one or both of the portable communications devices return in their home network.

The present invention will now be described with reference to the following drawings.

### BRIEF DESCRIPTION OF THE DRAWINGS

FIG. 1 is a schematic representation of a communications system according to an embodiment of the present invention.

FIG. 2 is a schematic representation of a portable communications device according to an embodiment of the present invention.

FIG. 3 is a flow chart of a method in accordance with an embodiment of the present invention.

### DESCRIPTION OF THE ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps.

Furthermore, any terms such as first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, any terms such as top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

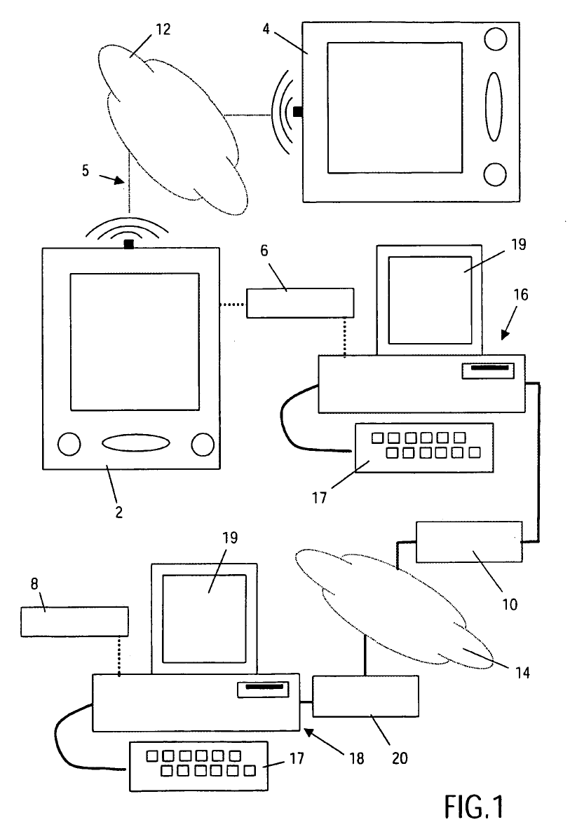

FIG. 1 is a schematic representation of an embodiment of the present invention having portable communications devices 2, 4 as well as first and second networks. An example of a combination of access technologies which can be used with a communications or computing device 2, 4 and methods and devices according to the present invention has been described in the European Project “Multiport”. A demonstrator was produced for a PDA with wireless LAN, GSM and UMTS capability for use in hospitals. The different access technologies allowed access to the LAN when in the hospital as well as remotely via mobile telephone networks when roaming outside the hospital. The first and second networks may be an ad-hoc and an infrastructure network, respectively. The devices 2, 4 are battery operated and may be any portable communications devices such as a pocket PC, PDA, smart phone, palm pilot, or dedicated laptop etc. Devices 2, 4 can communicate via a first communication path 5 using a first network address, e.g. an ad-hoc communication path 5 which supports an ad-hoc protocol such as Bluetooth, Infra-red, FireWire, USB, Wireless LAN etc. For clarification: an ad-hoc communication between two devices such as Bluetooth forms a “network” in accordance with the present invention. For example, the connection may be by an ad-hoc optical wireless communication method such as a Lino-of Sight (LOS) infra-red connection, across an air interface 12. The infra-red communication may be in accordance with the Infrared Data Association standard for example. Instead of Bluetooth, other radio communication standards may be used, e.g. “Home RF” may also be used. The connection may also be achieved using an access technology to a wireless LAN, e.g. in accordance with IEEE 802.11b. Alternatively, an ad-hoc connection can be by a cable connection, e.g. serial or twisted pair cables. Devices 2, 4 are provided with the necessary input/output devices, e.g. antenna and/or infra-red transmitter and receiver, to provide such ad-hoc communications. These input/output devices may be integral with the portable communications devices 2, 4 or may be attached to or inserted therein. For example, a Bluetooth attachment may be fitted to a mobile phone or other handheld device, may be an Acer Blue-contact module which adds functionality to a Handspring Visor PDA, an IBM Bluetooth wireless card, a 3COM Bluetooth PC card or a TDK Bluetooth card for insertion in a PCMCIA slot, etc.

Host devices 16 and 18 are provided, e.g. personal computers with a display 19 and a keyboard 17, as well as associated synchronisation interfaces 6, 8, respectively. The synchronisation interfaces 6, 8 may be docking interfaces such as cradles or docking stations or may comprise only a cable or optical wireless or radio wireless connection to a suitable port of the host, e.g. to a USB or a serial or parallel COM port, for example of a personal computer. The synchronisation interface 6, 8 may be radio, an electro-optical or an electromechanical interface suitable for synchronization of at least one of the portable communications devices 2, 4. For example the interface may support Bluetooth, Infra-red, FireWire, USB, Wireless LAN etc. or support a cable connection.

The host devices 16, 18 may also have connection to a shared resource network 14 such as a Local Area Network (LAN) or a Wide Area Network (WAN), e.g. the Internee via a suitable modem 10, 20, respectively. Such a modem may be a 56K telephone modem, an ADSL modem, a cable modem for broadband access to the Internet or similar. Such a network allows the host devices 16, 18 to communicate with each other, e.g. via the standard TCPAP protocol. All services available with the Internet may also be provided, e.g. Voice over IP (VoIP), e-mail, voice mail, transmission of multimedia files, browsing, FTP, etc. Alternatively, the host devices 16,18 may have a connection to a shared resource network 14 that does not require a modem 10,20.

In accordance, with an embodiment of the present invention, data transfers between portable communications devices 2, 4 which are made using a first address, e.g. those which are intended as ad-hoc transfers, may be delayed if a certain condition of the portable device is not met, e.g. a condition relating to the state of charge of the battery charge before or after the intended transfer, is not met. Assume two users both having a portable communications device 2, 4 want to share some video content. The portable communications devices 2, 4 have a memory, for this example, a hard disk is assumed. The data transfer can be possibly hundreds of megabytes. This requires a lot of power, not only for the hard disk, but also for some type of communications connection between the two devices using the first network (e.g. Bluetooth, Infra-red, FireWire, USB, Wireless LAN etc.). One or maybe even both users might not have sufficient battery power left to complete a full transfer and even if they did, they might be left with insufficient battery power after the communication until their next possibility to recharge.

Instead of completing a data transfer, information required to delay the data transfer to a point in time when power consumption is less of an issue, is collected. For example, this later time when power consumption is less of an issue could be when the portable communications device 2, 4 is connected to the synchronization interface such as to a cradle 6, 8 and has a connection with a permanent or large power supply such as mains electricity or a solar panel providing solar energy or the powerful battery of an automobile that is recharged by running the engine. Other alternative criteria may be taken into account in making the decision to delay the transfer, e.g. whether the portable communications device 2 and the portable communications device 4 are within radio communications range of each other. The information required to delay the data transfer may for example be collected at the beginning of the data transfer, sometime during the data transfer, or at the moment of delaying the data transfer

The collected information may for example comprise any of a filename, a file location, source and sink information such as one or more network addresses. Source information may for example include an IP address or hostname of the sending user's portable device or host device. The IP address or hostname can be used to find the user on the Internet. Sink information may for example include an IP address or hostname of the receiving user's portable device or host device. The collected information may be stored in a Transfer Queue. The Transfer Queue may contain multiple data transfer requests. The information may also comprise authentication information such as a username and/or a password.

The cradle 6, 8 is typically used for synchronization purposes. This means that after synchronization certain content on the host device 16, 18 is also on the portable communications devices 2, 4 and vice versa. New content on either the portable communications devices 2, 4 or the host device 16, 18 may be transferred when the portable communications devices 2, 4 are connected to the cradle 6, 8.

The Transfer Queue may be transferred to the host device 16, 18 every time when the portable communications device is connected to the cradle 6, 8. In another embodiment, one or both of the portable communication devices 2,4 are able to connect directly to the second network and no or only one host device is used. Once in the cradle 6, 8, there are several options to deal with the Transfer Queue.

Option (1)—“immediate transfer on docking”: In this option, the portable communications device 2, 4 has its own software application to start an Internet connection with other portable communications devices 2, 4 connected to the Internet when connected to their own synchronization interface, e.g. a cradle, 8, 6. The Transfer Queue contains sufficient information to set-up the Internet connection and to send or receive the data of interest. Favorably, partial data transfers may be supported as well as a resuming function in case the Internet connection is broken due to a connection failure or when the portable communications device is removed from the synchronization interface.

Option (2)—“indirect delayed transfer”: in this option the host device 16,18 has a software application that can perform the data transfer after the portable communications device 2,4 has provided the Transfer Queue. The host devices 16,18 of both users may then transfer the data of interest via an Internet connection even when the portable communications devices are not connected to the respective synchronization interface, e.g. a cradle. Next time when a portable communications device is connected to the cradle, it can check if new data is available as requested via the Transfer Queue. If so, it can use synchronization to retrieve the data.

Option (3)—hybrid solution: in this option a combination of both option (1) and (2) is provided. Partial data transfers between all systems involved may advantageously be supported.

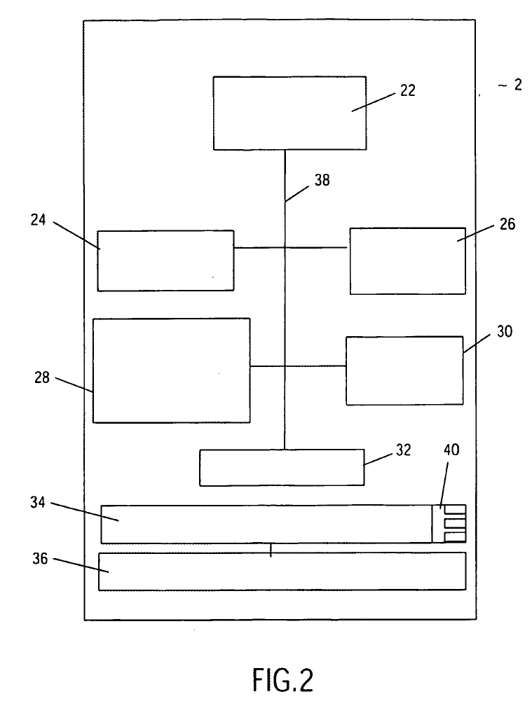

FIG. 2 is a block diagram illustrating one embodiment of a portable communications device 2 operable to execute a computer program in accordance with an embodiment of the present invention. The portable communications device 2 may be any of various types of portable communications devices. Examples of portable communications devices include personal digital assistants (PDAs), mobile terminals, handheld computers, wearable devices (e.g., wristwatch computers), “smart” cellular telephones, game consoles, global positioning system (GPS) units, electronic textbook devices, pocket PC's, etc. The devices may be configured for receipt of multimedia data and to display these appropriately, e.g. text, e-mail, video, still images, etc. New classes of portable communications devices are rapidly emerging, and this is not intended to be an exhaustive list.

As shown in FIG. 2, the portable communications device 2 may include a processor 22. The processor 22 may be any of various types, including a Pentium class processor as supplied by Intel Corp., USA, a PowerPC processor, as well as others. The processor 22 may have various clock speeds, including clock speeds similar to those found in desktop computer-class processors, as well as lower speeds such as 16 MHz.

The portable communications device 2 may also include a memory 30 coupled to the processor 22 by means of a bus system 38. The memory 30 may comprise any of various types of memory, including DRAM, SRAM, EDO RAM, flash memory, etc., or a non-volatile memory such as a magnetic media, e.g., a hard drive, or optical storage, or various combinations of these. The memory 30 may comprise other types of memory as well, or combinations thereof. In one embodiment, the memory 30 may have a small storage capacity.

The portable communications device 2 also includes an adhoc communication unit 24 for receiving data via a communication path, e.g. wirelessly such as infra-red or by radio, from other portable computing devices. The adhoc communication unit 24 may be operable to communicate with external devices using any of various wireless protocols and may include the required hardware therefore, e.g. antenna or infrared source and receiver. The portable communications device 2 also includes means 28 for communicating with a host computer via a synchronization interface, e.g. a docking interface. These means may be means for performing serial communication. The means 28 may make use of the unit 24 for synchronization with the host computer.

The portable communications device 2 may also comprise a display 26. The display 26 may be any of various types, such as an LCD (liquid crystal display). The display 26 for a typical portable communications device 2 may be small compared to the display of a desktop computer system, i.e. have a limited resolution in terms of number of pixels. A graphical user interface (GUI) may be displayed on the display 26. The processor 22 executing code and data from a part of the memory 30 may provide a means for generating and displaying the GUI.

The portable communications device 2 may also comprise an input means 32. The input means 32 may be any of various types, as appropriate for a particular portable communications device 2. For example, the input means may comprise one or more of a keypad, trackball, touch screen, touch pen, microphone, modem, infrared receiver, etc. The input means may be linked to the display, e.g. to a touch screen. The input means 32 may be adapted for user input, e.g. by means of a stylus and a touch screen.

The above elements are linked together with a suitable bus system 38. The portable communications device 2 also has one or more batteries 34, e.g. a rechargeable battery having a battery charge connection 40, and may also have an optional solar panel 36 for providing auxiliary power. Preferably, the battery charge connection 40 and the means 28 for communicating with the host computer via the synchronization interface connect automatically when the portable communications device 2 is located so as to be in communication over the synchronization interface, e.g. located in a docking station or cradle or connected to a docking cable.

The memory 30 may store a computer program. The program performs a method in accordance with the present invention when executed on the portable communications device 2, e.g. any of the three options (1) to (3) of the invention described above.

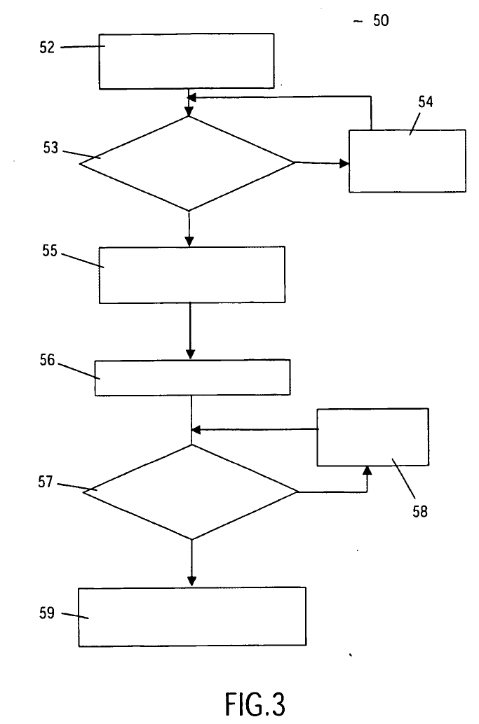

A flow diagram is shown in FIG. 3 for a method 50 in accordance with an embodiment of the present invention. The device 2 when performing the method detects in step 52 whether a first communication using a first network address, e.g. an adhoc communication, is to be made through a first network, e.g. via the adhoc communication unit 24. In step 53 it determines at least one condition related to the operation of the portable communications device, especially a condition relating to the charge state of a battery, e.g. the state of charge of the battery, or the signal quality of signals received from the second portable communications device. If the relevant condition meets a minimum requirement the result of step 53 is YES and the communication proceeds normally (step 54). If the relevant condition does not meet a minimum requirement the result of step 53 is NO and the program is adapted to collect the information necessary for the later transfer in step 55.

This collected information is part of the Transfer Queue and is stored in memory in step 56. In another embodiment, step 55 might also or alternatively be performed before step 53. The skilled person will appreciate from the above that in some way that there is a condition that determines whether to continue normal operation or not. In addition once in a while this condition is checked once or several times, e.g. at regular intervals. This check of a condition may be made just before a communication. In addition, even after the check has resulted in a decision that the condition is not met, a check can be made (whether or not this is the charge state of the battery) as to whether the condition has changed. This optional check is shown schematically as a feed-back loop from step 54 to step 53. The result of any check may be stored in a suitable memory location and may be accessed at a later date, e.g. just before a communication is to be made.

In step 57 it is determined whether the portable device is communicating with the host computer via a synchronization interface. If NO in step 57, waiting is continued in step 58. If YES in step 57, the transfer queue is transferred during a synch event to the host computer in step 59. As part of the synchronization and in accordance with one of the three embodiments described above the portable communications or computing device 2 can directly access a network such as a LAN or the Internet through the host device and resume the delayed communication using a second network address or the host device can run the request in the transfer queue (e.g. by making use of the second network address) or a hybrid of these. Effectively, the communication is delayed until it can be carried out via the means 28 for communicating with the host computer via the synchronization interface unless the condition changes in the mean time, e.g. new batteries are placed in the portable communications or computing device 2. Alternatively, the communication may be delayed until the portable communications device is directly connected to the second network, e.g. when the portable device is directly connected to an Ethernet hub or switch. As part of the synchronization one or more of the following functions may be carried out:
a) open and close databases on the portable device or the host,
b) upload or download data or a combination of both, as appropriate,
c) compare records on the portable device and the host,
d) add, delete or modify records in databases as appropriate on the portable device or the host,
e) convert data in one format on the portable device or host into data suitable for use on the host or portable device,
f) synchronize the clock on the host with the clock on the portable device,
g) “transaction processing”—transmission of data between the portable device and the host and processing of this data in one of these. Typically, this involves transfer of data from the portable device to the host for processing in the host.

The present invention provides a computer program product in the form of software for use with a portable communications device as described above which contains code for the execution of method steps when the software is executed on the portable device.

This software includes code which, when executed can initiate a transfer of data between the portable communications device and another device through a first network using a first network address, e.g. an ad-hoc communication with another device. It can also include code which, when executed, detects whether a communication between the portable communications device and another device through a first network using a first network address communication, is to be made, e.g. an ad-hoc communication. It also includes code which, when executed, determines whether a condition related to an operation of the portable communications device is above a minimum requirement. This code may be activated in response to the detection of a communication through the first network, e.g. an ad-hoc communication. It also includes code which, when executed, collects information required for resuming the data transfer through a second network using a second network address. For example, the software may also include code which, when executed, collects information required for a network connection for remote access to the other device. Further, code may be provided to initiate a communication through a synchronization interface, e.g. a docking interface or cradle, with a host computer and maintain such a communication. The software also includes code, which when executed, allows the communication through the first network if the condition is satisfied and delays the communication until the portable device is communicating with the host computer through the synchronization interface if the condition is not satisfied. If the portable communications device has a battery and is battery powered the condition can be a state of charge of the battery before the communication through the first network is carried out or the state of charge of the battery estimated assuming the communication thorough the first network would have been carried out. Alternatively, or additionally the condition may be a quality of a signal received from the other device. The software may also comprise code which when executed, initiates a network connection for remote access to the other device when the portable device is communicating with the host computer via a synchronization interface. The collected information may be retrieved from the other device. The collected information may include at least a network address of a host computer associated with the other device.

In accordance with embodiments of the present invention, the computer program product can reside in computer storage, e.g. in a part of the memory 30 mentioned above. However, it is important that while the present invention has been, and will continue to be, that those skilled in the art will appreciate that the mechanisms of the present invention are capable of being distributed as a program product in a variety of forms, and that the present invention applies equally regardless of the particular type of signal bearing media used to actually carry out the distribution. Examples of computer readable signal bearing media include on which the computer program product can be stored are: recordable type media such as floppy disks and CD or DVD ROMs and transmission type media such as digital and analogue communication links.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

1. A portable communications device (2) comprising:
means (24) to transfer data between the portable communications device (2) and another device (4) through a first network (12) using a first network address;
means for determining whether a condition related to the operation of the portable communications device (2) is above a minimum requirement;
means for collecting information required for resuming the data transfer through a second network (14) using a second network address different from the first network address; and
means for allowing the data transfer through the first network (12) if the condition is satisfied and for delaying the data transfer through the first network (12) if the condition is not satisfied.

2. The portable communications device according to claim 1, further comprising means for resuming the data transfer through the second network (14).

3. The portable communications device according to claim 1, further comprising means for instructing a host computer (16) to resume the data transfer through the second network ( 14).

4. The portable communications device according to claim 3, further comprising a synchronization interface (6) to which one or both of the portable communications device (2,4) and the host computer (16) can be coupled.

5. The portable communications device according to claim 4, wherein the means for instructing a host computer (16) includes the synchronization interface (6).

6. The portable communications device according to claim 1, wherein the portable communications device (2) has a battery (34) and is battery powered and the condition is a state of charge of the battery (34) before the communication through the first network is carried out.

7. The portable communications device according to claim 1, wherein the portable communications device (2) has a battery (34) and is battery powered and the condition is a state of charge of the battery (34) estimated assuming the communication through the first network would have been completed.

8. The portable communications device according to claim 1, wherein the condition is a quality of a signal received from the other device.

9. The portable communications device according to claim 1, wherein the information includes the second network address, the second network address being a network address of a host computer (18) associated with the other device (4).

10. The portable communications device according to claim 1, wherein the first network (12) is an ad-hoc network and the second network (14) is an infrastructure network.

11. A communications system comprising portable communications devices (2,4), each portable communication device comprising means (24) to transfer data between the one portable communications device (2,4) and the other portable device (4,2) through a first network (12) using a first network address;
means for determining whether a condition related to the operation of the one portable communications device (2) is above a minimum requirement;
means for collecting information required for resuming the data transfer through a second network (14) using a second network address different from the first network address; and
means for allowing the data transfer through the first network (12) if the condition is satisfied and for delaying the data transfer through the first network (12) if the condition is not satisfied.

12. The communications system according to claim 11, further comprising a host computer (16).

13. The communications system according to claim 12, wherein the host computer (16) comprises means for initiating a network connection to the other device (4) through the second network (14).

14. A method of operating a portable communications device (2), the method comprising:
determining whether data is to be transferred between the portable communications device (2) and another device (4) through a first network (12) using a first network address;
determining whether a condition related to the operation of the portable communications device (2) is above a minimum requirement;
collecting information required for resuming the data transfer through a second network (14) using a second network address different from the first network address; and
allowing the data transfer through the first network (12) if the condition is satisfied and delaying the data transfer through the first network (12) if the condition is not satisfied.

15. A computer program product comprising code which when executed on a portable communications device (2) enables the portable device to:
determine whether there is to be a transfer of data between the portable communications device (2) and another device (4) through a first network (12) using a first network address;
determine whether a condition related to an operation of the portable communications device (2) is above a minimum requirement;
collect information required for resuming the data transfer through a second network (14) using a second network address; and
allow the data transfer through the first network (12) if the condition is satisfied and delay the data transfer through the first network (12) if the condition is not satisfied.

16. A computer readable storage medium storing the computer program product of claim 15.
